(19) United States
(12) Patent Application Publication
(10) Pub. No.: US 2005/0108377 A1
(43) Pub. Date: May 19, 2005

(54) Method for detecting abnormal traffic at network level using statistical analysis

(76) Inventors: Soo-Hyung Lee, Daejon (KR); Beom-Hwan Chang, Daejon (KR); Jin-Oh Kim, Daejon (KR); Jung-Chan Na, Daejon (KR); Sung-Won Sohn, Daejon (KR); Chee-Hang Park, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,502

(22) Filed: Dec. 31, 2003

(30) Foreign Application Priority Data
Nov. 18, 2003 (KR) 2003-81833

(51) Int. Cl. G06F 15/173

(52) U.S. Cl. 709/223

(57) ABSTRACT

Disclosed is a method of detecting abnormal traffic at the network level using a statistical analysis and a computer-readable recording medium for recording a program that implements the method. The method includes the steps of: a) gathering local traffic data from each network device and integrating a plurality of the local traffic data to generate traffic data in a network level; b) extracting a characteristic traffic data based on the traffic data in the network level; c) comparing the characteristic traffic data with a characteristic traffic data profile resulting from statistical computations, and determining whether there is abnormal traffic in the network; and d) updating the characteristic traffic data profile using the characteristic traffic data if there is no abnormal traffic in the network, analyzing seriousness of the abnormal traffic and monitoring the abnormal traffic if there is abnormal traffic in the network.

### FIELD OF THE INVENTION

The present invention relates to a method for detecting abnormal traffic at the network level using a statistical analysis and a computer-readable recording medium for recording a program that implements the same method; and more particularly, to a method for detecting abnormal traffic in a timely manner using a statistical analysis, where the abnormal traffic is triggered by either an error in a network set-up or cyber attacks intent on degrading a performance at a network level, and a computer-readable recording medium for recording a program that implements the method.

### DESCRIPTION OF RELATED ART

In a general procedure for detecting abnormal traffic in a network, firstly, a network manager monitors a comparative values or graphs showing a network traffic volume gathered in the network and a normal traffic volume obtained from statistical computations, and then, analyses the comparative values or graphs to determine whether or not there is abnormal traffic in the network based on the network manager's experience.

Here, the ‘abnormal traffic’ means abnormal increase of the network traffic volume that causes bottlenecks in the network and degrades network performance. The abnormal traffic may be triggered by either a glitch in the network set-up, cyber attacks or increase in the number of clients who want access to the network.

FIG. 1 is a diagram illustrating a conventional method of detecting abnormal traffic in a network.

As shown, an Internet Service Provider (ISP 1) includes a network management server (NMS) 111 for controlling the ISP 1 and a plurality of network devices 110, e.g., a router. Here, the function of the network device 110 is to provide a gateway to a second Internet Service Provider (ISP 2) or a number of local domains 112.

The network device 110 has a management agent for gathering traffic data on a node, a domain and a link.

The NMS 111 gathers up pieces of the traffic data from the network devices 110 and then passes the traffic data to the network manager via a management console. Based on the traffic data, the network manager determines whether or not there is abnormal traffic in the network.

In the conventional method of detecting abnormal traffic in a network, the gathering of the traffic data is mainly targeted at specific traffic in a particular local domain, to thereby make a right judgment on the overall network performance in a timely manner.

### SUMMARY OF THE INVENTION

It is, therefore, an object of the present invention to provide a method of detecting abnormal traffic in a timely manner using a statistical analysis, where the abnormal traffic is triggered by either an error in a network set-up or cyber attacks intent on degrading a performance at a network level, and a computer-readable recording medium for recording a program that implements the method.

In accordance with an aspect of the present invention, there is provided a method for detecting abnormal traffic at the network level using a statistical analysis, the method including the steps of: a) gathering local traffic data from each network device and integrating a plurality of the local traffic data to generate traffic data in a network level; b) extracting a characteristic traffic data based on the traffic data in the network level; c) comparing the characteristic traffic data with a characteristic traffic data profile resulting from statistical computations, and determining whether there is abnormal traffic in the network; and d) updating the characteristic traffic data profile using the characteristic traffic data if there is no abnormal traffic in the network, analyzing seriousness of the abnormal traffic and monitoring the abnormal traffic if there is abnormal traffic in the network.

In accordance with another aspect of the present invention, there is provided a computer-readable recording medium for storing a program that implements a method for detecting abnormal traffic at the network level using a statistical analysis, the method including the steps of: a) gathering local traffic data from each network device and integrating a plurality of the local traffic data to generate traffic data in a network level; b) extracting a characteristic traffic data based on the traffic data in the network level; c) comparing the characteristic traffic data with a characteristic traffic data profile resulting from statistical computations, and determining whether there is abnormal traffic in the network; and d) updating the characteristic traffic data profile using the characteristic traffic data if there is no abnormal traffic in the network, analyzing seriousness of the abnormal traffic and monitoring the abnormal traffic if there is abnormal traffic in the network.

### BRIEF DESCRIPTION OF THE DRAWINGS

The above and other objects and features of the present invention will become apparent from the following description of the preferred embodiments given in conjunction with the accompanying drawings, in which:

FIG. 1 is a diagram illustrating a conventional method for detecting abnormal traffic in a network;

FIG. 2 is a diagram illustrating a method for detecting abnormal traffic at a network level using a statistical analysis in accordance with an embodiment of the present invention; and

FIG. 3 is a flow chart showing a method of detecting abnormal traffic at a network level using a statistical analysis in accordance with an embodiment of the present invention.

### DETAILED DESCRIPTION OF THE INVENTION

Other objects and aspects of the invention will become apparent from the following description of the embodiments with reference to the accompanying drawings, which is set forth hereinafter.

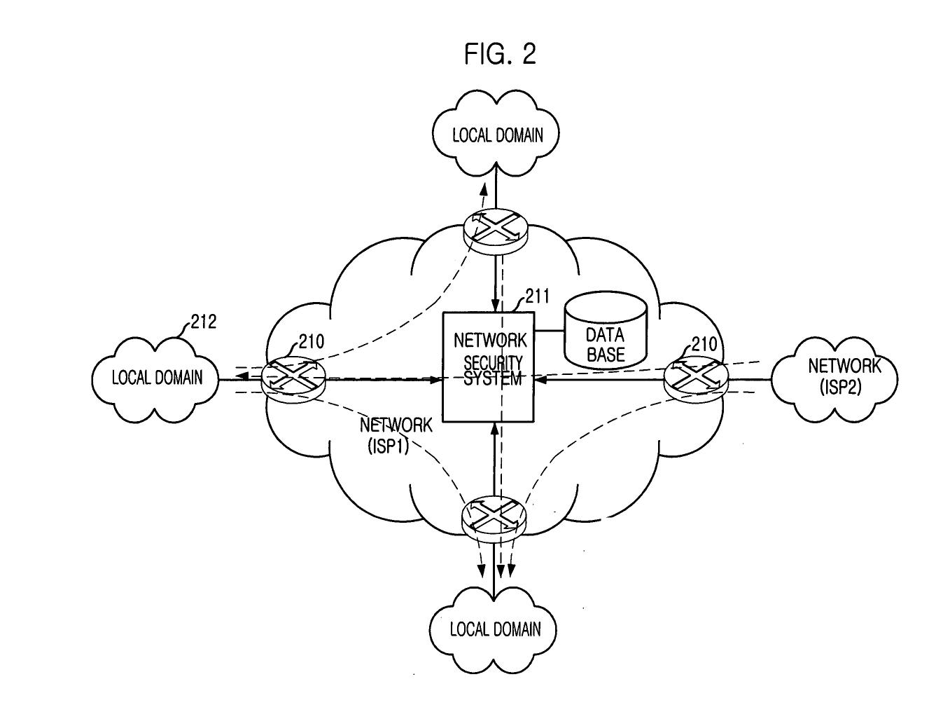

FIG. 2 is a diagram illustrating a method for detecting abnormal traffic at a network level using a statistical analysis in accordance with an embodiment of the present invention.

As shown, a network security system (NSS) 211 having a traffic sensing module can communicate with a number of local domains as well as another network (ISP2) via a network device 210 such as a router. The function of the network device 210 is to gather up pieces of network information from either a local domain or the ISP2.

In more detail, the network security system (NSS) 211 gathers up pieces of local traffic data from network devices 210 on a regular basis, sums up the local traffic data in an overall network to generate traffic data in a network level. The NSS 211 extracts a characteristic traffic data based on the traffic data in the network level, and then, compares the characteristic traffic data in the network level to a characteristic traffic data profile which shows traffic data in a normal condition and is obtained from statistical computations, to thereby determine whether there is abnormal traffic in a network level.

Here, the characteristic traffic data includes a various kinds of data, for example, information on traffic assigned to an application port which is selected according to an application service; information on traffic of which packet size is identical; and information on traffic of which the number of source-destination pairs, which represents the number of source addresses of the traffic having the same target address.

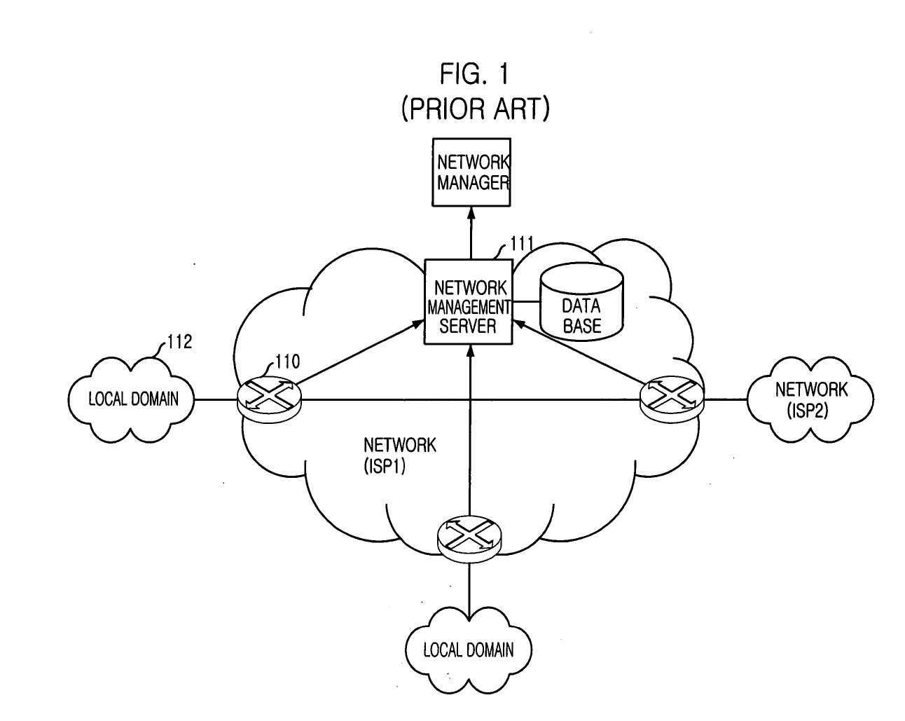

The traffic data is gathered by the network device 210, which is similar to the network device 110 of FIG. 1 and has a management agent for gathering traffic data on a node, a domain and a link. Accordingly, the traffic data can be gathered without adding or changing the network devices.

The NMS 111 gathers up pieces of the traffic data from the network devices 110 and then passes the traffic data to the network manager via a management console. Based on the traffic data, the network manager determines whether or not there is abnormal traffic in the network.

A network security system 211 performs security function of the network and detects abnormal traffic in the network. In the network security system, is installed a statistical analysis module so as to detect the abnormal traffic in the network. The network security system 211 gathers up traffic data, extracts a characteristic traffic data from the traffic data, compares the characteristic traffic data to a reference traffic data, which is obtained from statistical computations and represents a normal traffic condition, and determines whether there is abnormal traffic at the network level. If there is the abnormal traffic, seriousness of the abnormal traffic is analyzed and analysis result data is generated.

The analysis result data can be reported to the network manager together with the network security information, and can be used to solve the system failure automatically.

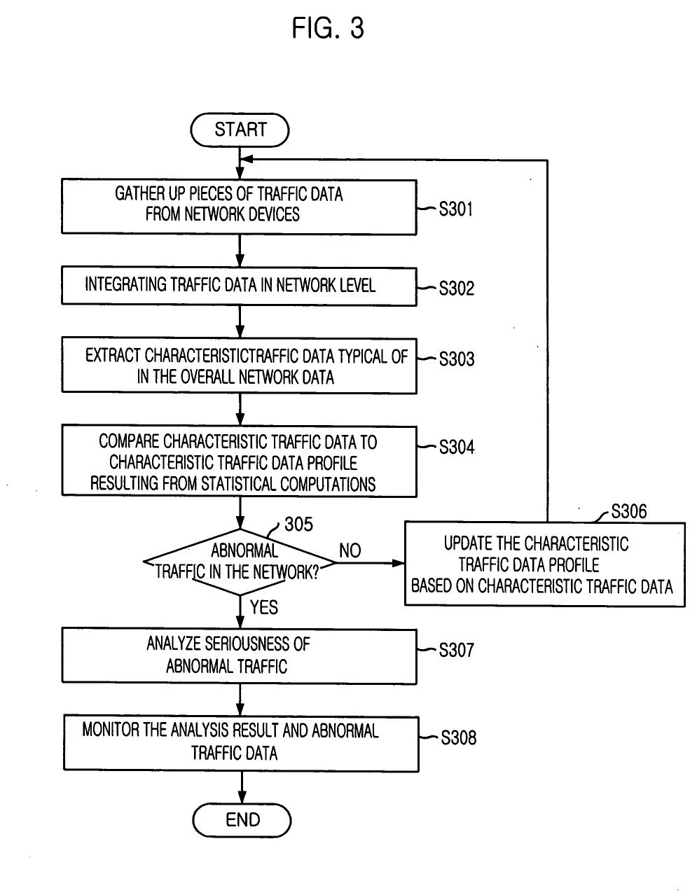

FIG. 3 is a flow chart illustrating a method of detecting abnormal traffic at the network level using a statistical analysis in accordance with an embodiment of the present invention.

First, a user sets up an execution environment that includes a reference value representing the abnormal traffic, a period of traffic analysis and a method of processing the analysis result data. In a database, is stored a characteristic traffic data profile, which is obtained from statistical computations and represents normal traffic.

At step S301, network information is gathered up from each network device 210. At step S302, the parts of the traffic data are integrated in overall network to generate traffic data in a network level.

At step S303, characteristic traffic data is extracted from the traffic data in a network level according to a criterion of a user's choice.

At step S304, the characteristic traffic data is compared to the characteristic traffic data profile resulting from statistical computations and representing the normal traffic. At step S305, based on the comparison result at the step S305, it is determined whether or not there exists abnormal traffic in a network level.

At step S306, the characteristic traffic data profile is updated using the characteristic traffic data, if there is no abnormal traffic. After performing the step s3O6, the process continues to the step S301 to repeat the steps S301 to S306, which is necessary to obtain accurate normal traffic data.

At the step S305, if there is the abnormal traffic in the network, seriousness of the abnormal traffic is analyzed based on a reference level at step S307. At step S308, analysis result on the seriousness of the abnormal traffic and the characteristic traffic data are transferred to a failure processing system.

As described above, the traffic in the network is monitored on a regular basis to detect the abnormal traffic. In another embodiment, the abnormal traffic can be detected in the network device 210, which has a drawback to occur overload on the network device 210.

The method of detecting abnormal traffic in the network based on a statistical analysis can be implemented in the form of computer software where the software is stored onto a computer readable recording medium, e.g., a compact disk ROM (CD-ROM), a random access memory (RAM), a read only memory (ROM), a floppy disk, a hard disk and a magneto-optical disk.

In the traffic detection method, the abnormal traffic is efficiently detected within a short time by comparing the characteristic traffic data extracted from the traffic data of the overall network and the characteristic traffic data profile representing the normal traffic.

Based on the characteristic traffic data profile representing the normal traffic, the network security system can detect the abnormal traffic without operation of the network manager, to thereby process the abnormal traffic before the network failure.

While the present invention has been described with respect to certain preferred embodiments, it will be apparent to those skilled in the art that various changes and modifications may be made without departing from the scope of the invention as defined in the following claims.

1. A method for detecting abnormal traffic at the network level using a statistical analysis, the method comprising the steps of:
a) gathering local traffic data from each network device and integrating a plurality of the local traffic data to generate traffic data in a network level;
b) extracting a characteristic traffic data based on the traffic data in the network level;
c) comparing the characteristic traffic data with a characteristic traffic data profile resulting from statistical computations, and determining whether there is abnormal traffic in the network; and
d) updating the characteristic traffic data profile using the characteristic traffic data if there is no abnormal traffic in the network, analyzing seriousness of the abnormal traffic and monitoring the abnormal traffic if there is abnormal traffic in the network.

2. The method as recited in claim 1, wherein the characteristic traffic data includes:
information on traffic assigned to an application port which is selected according to an application service;
information on traffic of which packet size is identical; and
information on traffic of which the number of source-destination pairs, which represents the number of source addresses of the traffic having the same target address.

3. The method as recited in claim 1, further comprising the step of e) transmitting the analysis result of the seriousness of the abnormal traffic to an abnormal traffic processing system.

4. A computer-readable recording medium for storing a program that implements a method for detecting abnormal traffic at the network level using a statistical analysis, the method comprising the steps of:
a) gathering local traffic data from each network device and integrating a plurality of the local traffic data to generate traffic data in a network level;
b) extracting a characteristic traffic data based on the traffic data in the network level;
c) comparing the characteristic traffic data with a characteristic traffic data profile resulting from statistical computations, and determining whether there is abnormal traffic in the network; and
d) updating the characteristic traffic data profile using the characteristic traffic data if there is no abnormal traffic in the network, analyzing seriousness of the abnormal traffic and monitoring the abnormal traffic if there is abnormal traffic in the network.
